(19) United States
(12) Patent Application Publication
(10) Pub. No.: US 2009/0314200 A1
(43) Pub. Date: Dec. 24, 2009

(54) APPARATUS FOR DISPENSING GLUE ONTO OPTICAL ELEMENT

(75) Inventor: TSUNG-YU LIN, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: HON HAI PRECISION INDUSTRY CO., LTD., Tu-Cheng (TW)

(21) Appl. No.: 12/471,393

(22) Filed: May 24, 2009

(30) Foreign Application Priority Data
Jun. 20, 2008 (CN) 200810302250.5

(51) Int. Cl. B05C 5/02

(52) U.S. Cl. 118/300

(57) ABSTRACT

An apparatus for dispensing glue onto an optical element includes a cylindrical main body and an pneumatic source. The main body defines a cavity configured for accommodating glue. An end of the main body has a bottom surface, which defines a recess in a central portion thereof and an annular groove in a peripheral portion thereof. The annular groove surrounds the recess and is in communication with the cavity. The pneumatic source communicates with the cavity and is configured for providing pressurized air to the cavity thereby allowing the glue to flow out from the annular groove and dispense onto a peripheral portion of the optical element.

### BACKGROUND

1. Technical Field

The present disclosure generally relates to apparatus for assembling lens modules, and more particularly relates to an apparatus for dispensing glue onto an optical element.

2. Description of Related Art

Nowadays, lens modules are widely employed in electronic devices, such as camera systems and mobile phones, for image capturing. Generally, a lens module includes a lens barrel and a number of optical elements, such as lens, spacers, and filters (e.g., infrared (IR)-cut filters). The optical elements are received in the lens barrel and arranged along an optical axis thereof one after the other from an object side to an image side of the lens module.

In assembly, firstly, an optical element, e.g. a lens, is secured into a lens barrel by a vacuum nozzle. Secondly, a tamping rod is used to push the lens to the bottom of the lens barrel. Thirdly, a glue dispenser including a container configured for accomodating glue and a nozzle in communication with the container is provided. Fourthly, the lens barrel is placed on a rotating platform, the nozzle of the glue dispenser is positioned adjacent to a peripheral portion of the lens, then the rotating platform is actuated to rotate after that. Thus the lens barrel positioned thereon undergoes a simultaneous rotary movement therewith, meanwhile glue in the container is forced to flow out from the nozzle and dispensed onto the peripheral portion of the lens. Fifthly, another optical element, e.g., a spacer, is secured into the lens barrel by the vacuum nozzle, and is pushed by the tamping rod until the spacer is intimately in contact with the lens and bonded with the lens via glue distributed on the peripheral portion thereof. Sixthly, the glue dispenser dispenses glue on the spacer, and other optical elements can be secured into the lens barrel and bonded with the spacer according to the similar steps aforementioned until the lens module is completely assembled.

The conventional assembling process needs at least two assembling fixtures, i.e., the glue dispenser and the tamping rod. Therefore, the conventional assembling process is complicated and time consuming.

What is needed, therefore, is an apparatus for dispensing glue onto an optical element so as to simplify a process of assembling a lens module.

### BRIEF DESCRIPTION OF THE DRAWINGS

Many aspects of the present embodiment can be better understood with reference to the following drawings. The components in the drawings are not necessarily drawn to scale, the emphasis instead being placed upon clearly illustrating the principles of the present embodiment. Moreover, in the drawings, like reference numerals designate corresponding parts throughout the several views.

FIG. 1 is a schematic view of an apparatus for dispensing glue onto an optical element, in accordance with a first embodiment.

FIG. 2 is a sectional view of the apparatus, taken along line II-II of FIG. 1.

FIG. 3 is a bottom view of the apparatus of FIG. 1.

FIG. 4 is similar to FIG. 1, but showing glue applied on a peripheral region of a lens using the apparatus.

FIG. 5 is a schematic view of an apparatus for dispensing glue onto an optical element, in accordance with a second embodiment.

### DETAILED DESCRIPTION

Embodiments will now be described in detail below and with reference to the drawings.

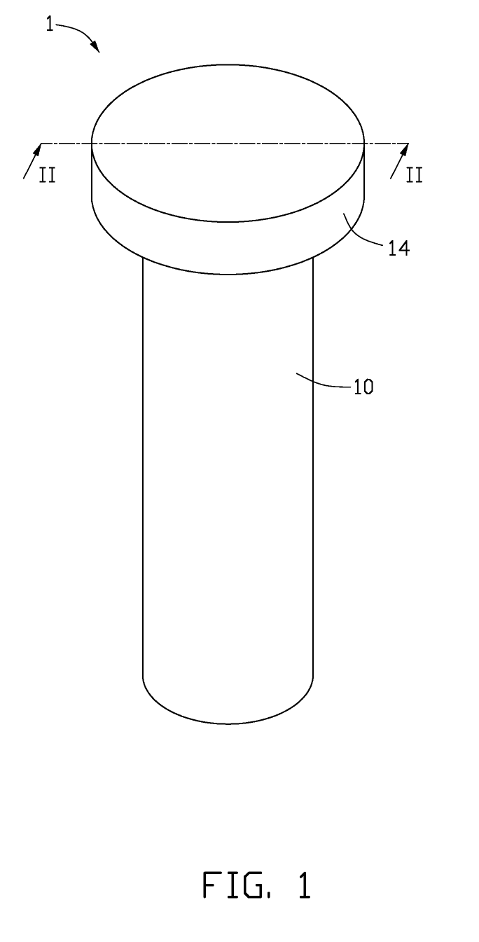

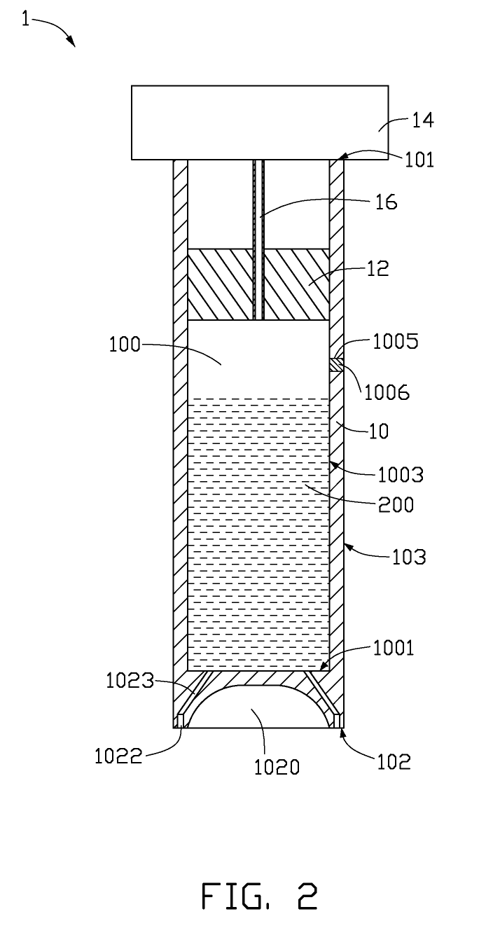

Referring to FIG. 1 to FIG. 3, an exemplary apparatus 1 is shown. The apparatus 1 is configured for dispensing glue onto an optical element, and positioning the optical element in place. The optical element can be a lens, a spacer, a filter, a soma, or other suitable element, and includes a central optical portion and a peripheral portion. The apparatus 1 includes a cylindrical main body 10, a sealing plate 12, a pneumatic source 14, and a gas pipe 16.

The main body 10 defines a cavity 100 therein, and has a top surface 101, a bottom surface 102, an outer side surface 103, an inner bottom surface 1001 in the cavity 100, and an inner side surface 1003 in the cavity 100. The cavity 100 is configured for accommodating glue 200. The top surface 101 and the bottom surface 102 are at two opposite ends of the main body 10. The outer side surface 103 is connected between the top surface 101 and the bottom surface 102. The inner bottom surface 1001 is parallel and adjacent to the bottom surface 102. In the illustrated embodiment, the cavity 100 is exposed at the top surface 101 of the main body 10, thus that the inner side surface 1003 is connected between the top surface 101 and the inner bottom surface 1001. A refilling hole 1002 is defined through the inner side surface 1003 and the outer side surface 103, thus the cavity 100 can be refilled with glue 200 via the refilling hole 1002. A sealing member 1006 is engaged in the refilling hole 1005 to seal the refilling hole 1005, thus preventing leakage of the glue 200 from the cavity 100.

In particular, the bottom surface 102 has a diameter substantially equal to or little less than that of the optical element, and is configured for being in contact with the optical element. The bottom surface 102 defines a recess 1020 in a central portion thereof and an annular groove 1022 in a peripheral portion thereof. The recess 1020 is configured for accommodating the central optical portion of the optical element. The annular groove 1022 is defined around the recess 1020, and is in communication with the cavity 100 via a plurality of channels 1023. In detail, the channels 1023 extend from the cavity 100 to the annular groove 1022. Preferably, the channels 1023 are equally angularly spaced from one another about a central axis axis of the main body 10.

The sealing plate 12 is fixed in the cavity 100 and adjacent to the top surface 101. A sidewall of the sealing plate 12 is intimately in contact with the inner side surface 1003, and therefore, tightly seals the cavity 100. The pneumatic source 14 is configured for providing pressurized air, and is in communication with the cavity 100 via the air pipe 16. Therefore, the glue 200 can be forced to flow out from the cavity 100 via the channels 1023 by a drive of the pressurized air and then be dispensed onto the peripheral portion of the optical element via the annular groove 1022.

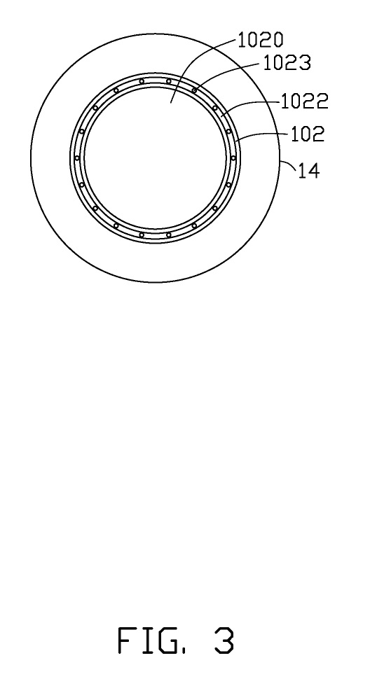

It is understood that the detail structure of pneumatic source 14 is not shown in FIG. 3. In the illustrated embodiment, the pneumatic source 14 is attached on the top surface 101, one end of the air pipe 16 penetrates through the sealing plate 12, and another end of the air pipe 16 is connected with the pneumatic source 14.

In other embodiments the refilling hole 1005 and the sealing member 1006 may be omitted, and the glue 200 also can be injected into the cavity 100 by taking out the sealing plate 12 and the pneumatic source 14 temporarily.

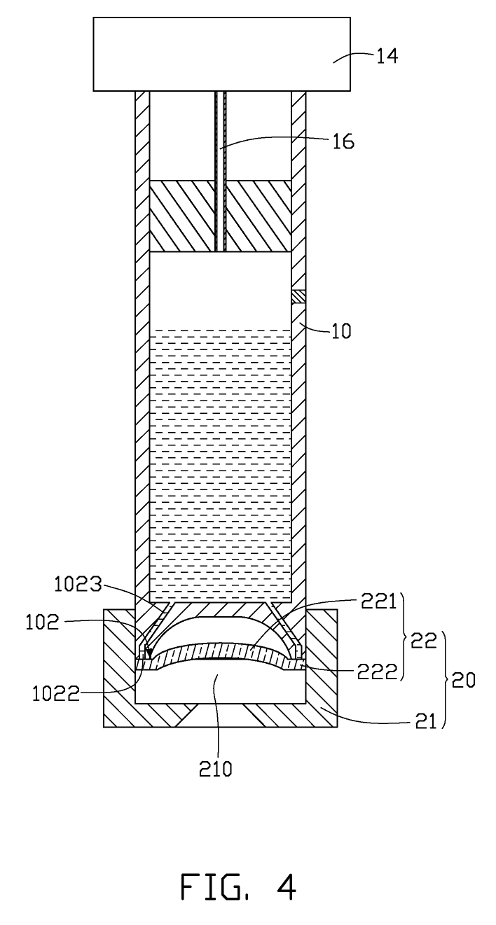

Referring to FIG. 4, the apparatus 1 is used for assembling a lens module 20 which includes a lens barrel 21 and at least a lens 22, wherein, assembling steps are described following:

Firstly, the lens 22 is disposed into a cavity 210 of the lens barrel 21 by a vacuum nozzle (not shown). The lens 22 includes a central optical portion 221 and a peripheral portion 222.

Secondly, the main body 10 of the apparatus 1 is inserted into the lens barrel 21, such that the bottom surface 102 is in contact with the lens 22. In this circumstance, a central optical portion 221 of the lens 22 is received in the recess 1020, while a peripheral portion 222 of the lens 22 is in contact with the second ending surface 102.

Thirdly, the lens 22 is pushed by the main body 10 until the lens 22 is located in the predetermined position, e.g., at the bottom of the lens barrel 21, meanwhile the pneumatic source 14 provides pressurized air to the cavity 100 via the air pipe 16, therefore, the glue 200 is pressurized and flows out from the annular groove 1022 via the channels 1023. Due to the annular groove 1022 being above the peripheral portion 222 of the lens 22, the glue 200 flows out from the annular groove 1022 onto the peripheral portion 222.

Fourthly, the main body 10 is taken out form the lens barrel 21, and other optical elements can be assembled into the lens barrel 21 and securely bonded onto the lens 22, according to the similar steps above.

Compared with the conventional assembling process, the apparatus 1 can be used to press the lens 22 while distribute glue 200 onto the lens 22. Therefore, the assembling process is simplified and a speed for assembling lens module 20 is improved.

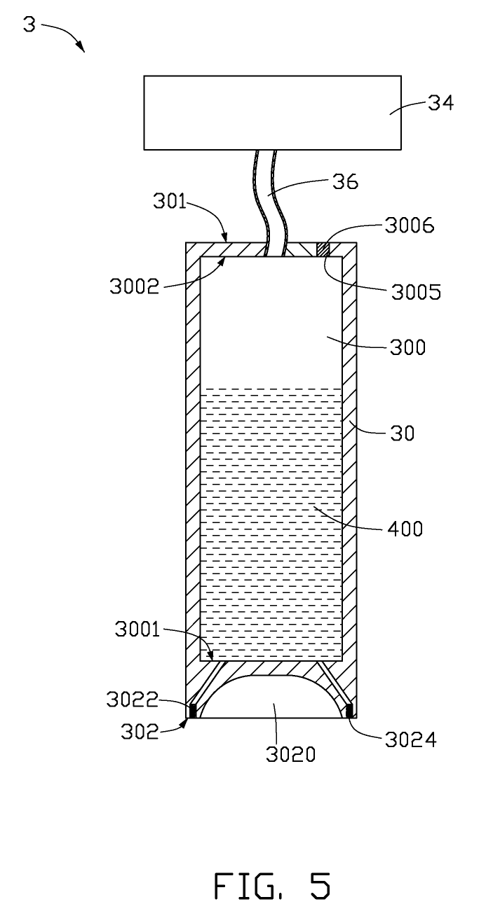

Referring to FIG. 5, an apparatus 3 in accordance with a second embodiment is shown. The apparatus 3 includes a cylindrical main body 30, a pneumatic source 34, and a gas pipe 36. The main body 30 defines a cavity 300 therein, and includes a top surface 301, a bottom surface 302, an inner bottom surface 3001 in the cavity 300, and an inner top surface 3002 in the cavity 300. The cavity 300 is configured for accommodating glue 400. The top surface 301 and the bottom surface 302 are at two opposite ends of the main body 30. The inner bottom surface 3001 is adjacent to the bottom surface 302, and the inner top surface 3002 is adjacent to the top surface 301.

A refilling hole 3005 is defined through the top surface 301 and the inner top surface 3002, and is configured for introducing refill glue into the cavity 300. A sealing member 3006 is engaged in the refilling hole 3005 to seal the refilling hole 3005.

The second ending surface 302 also defines a recess 3020 in a central portion thereof and an annular groove 3022 in a peripheral portion thereof. Specifically, an annular shaped absorbing material 3024 like a sponge is positioned in the annular groove 3022, aiding in uniform distribution of the glue 400.

In the illustrated embodiment, the gas pipe 36 is a flexible pipe, therefore the pneumatic source 34 can be conveniently positioned most anywhere around the main body 30.

The apparatus 3 also can be used to assemble lens modules, and improve the speed of assembling in the art.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

1. An apparatus for dispensing glue onto an optical element, the optical element having a central optical portion and a peripheral portion surrounding the central optical portion, the apparatus comprising:
a cylindrical main body defining a cavity configured for accommodating glue, an end of the cylindrical main body comprising a bottom surface, a recess defined in a central portion of the bottom surface, the recess being configured for receiving the central portion of the optical element, an annular groove defined in a peripheral portion of the bottom surface, the annular groove surrounding the recess and being in communication with the cavity; and
a pneumatic source capable of providing pressurized air, the pneumatic source communicating with the cavity of the main body and configured for forcing the glue to flow out from the annular groove and be dispensed onto the peripheral portion of the optical element.

2. The apparatus as claimed in claim 1, wherein the cylindrical main body defines a plurality of channels each communicating with the annular groove and the cavity.

3. The apparatus as claimed in claim 2, wherein the channels are equally angularly spaced from one another about a central axis of the main body.

4. The apparatus as claimed in claim 1, further comprising an air pipe in communication with the pneumatic source and the cavity.

5. The apparatus as claimed in claim 4, wherein the air pipe is a flexible pipe.

6. The apparatus as claimed in claim 1, wherein the main body further comprises a refilling hole for introducing refill glue into the cavity and a sealing member for sealing the refilling hole.

7. The apparatus as claimed in claim 1, wherein the main body further comprises a top surface at an opposite end of the main body to the bottom surface, and the cavity is exposed at the top surface.

8. The apparatus as claimed in claim 7, further comprising a sealing plate configured to seal the cavity, the sealing plate being positioned in the cavity and adjacent to the top surface.

9. The apparatus as claimed in claim 8, further comprising an air pipe in communication with the pneumatic source and the cavity, an end of the air pipe penetrating the sealing plate.

10. The apparatus as claimed in claim 7, wherein the main body further comprises an inner side surface in the cavity, an outer side surface connected between the top surface and the bottom surface, a refilling hole defined through the inner side surface and the outer side surface, and a sealing member for sealing the refilling hole, the refilling hole is configured for introducing refill glue into the cavity.

11. The apparatus as claimed in claim 1, further comprising an absorbing material positioned in the annular groove.

12. The apparatus as claimed in claim 11, wherein the absorbing material is a sponge.

13. The apparatus as claimed in claim 1, wherein the main body further comprises a top surface at an opposite end of the main body to the bottom surface, and the pneumatic source is attached on the top surface.

14. The apparatus as claimed in claim 1, wherein the main body further comprises a top surface at an opposite end of the main body to the bottom surface, an inner bottom surface in the cavity, and an inner top surface in the cavity, and the inner top surface is opposite to the inner bottom surface.

15. The apparatus as claimed in claim 14, further comprising an air pipe in communication with the pneumatic source and the cavity, an end of the air pipe penetrating through the top surface and the inner top surface.

16. The apparatus as claimed in claim 14, wherein the main body further comprises a refilling hole and a sealing member, the refilling hole is defined through the top surface and the inner top surface and is configured for introducing refill glue into the cavity, and the sealing member is engaged in the refilling hole.
